(19) United States
(12) Patent Application Publication
(10) Pub. No.: US 2022/0040015 A1
(43) Pub. Date: Feb. 10, 2022

(54) THE WHEELCHAIR DRIVE UNIT AND THE METHOD OF MOUNTING THE DRIVE UNIT TO A WHEELCHAIR

(71) Applicant: Mitosz KRAWCZYK, Warsaw (PL)

(72) Inventor: Mitosz KRAWCZYK, Warsaw (PL)

(21) Appl. No.: 17/276,635

(22) PCT Filed: Oct. 10, 2019
(86) PCT No.: PCT/PL2019/000090

§ 371 Date: Mar. 16, 2021

(30) Foreign Application Priority Data
Oct. 15, 2018 (PL) P. 427414

(51) Int. Cl. A61G 5/04; A61G 5/10

(52) U.S. Cl. CPC A61G 5/04; A61G 5/1051

(57) ABSTRACT

After manually setting the length of the variable length connecting element (6) that connects drive unit to the wheelchair with the specified seat length, the drive control sub-assembly (10) starts. The element (6), driven by the drive sub-assembly (10), moves down until it rests on the axle connecting the wheelchair wheels. At the same time, the unit frame (1) whose horizontal segment is placed under the footrest of the wheelchair also moves.

The connecting element (6) that connects the drive unit to the wheelchair as well as the end of the drive sub-assembly (10) whose other end is connected to the connecting element (6) are attached to the frame (1) mounted on the clamp (2) located on the steering system (3). The frame comprises of a horizontal segment and a segment forming an obtuse angle with the ground, while the horizontal part, which, after connecting the unit with the wheelchair, fits under the footrest, has two components (12), (13).

The subject matter of the invention is a method of mounting the drive unit to a wheelchair and, furthermore, a wheelchair drive unit for using with this method allowing the reversible conversion of a known hand wheelchair into a three-wheeled wheelchair with a drive, in particular with the electric drive.

We know the solution that allows to attach a drive to a hand wheelchair. The adaptation of the wheelchair to connect the drive consists of screwing four cube clamps that can be mounted permanently to the wheelchair frame with a help of a wrench. A frame with a lock is attached to the cube clamps and thus the wheelchair is already adapted to attach the drive. The drive is connected by inserting the frame bolt into the lock under the seat and straightening the drive to the vertical position. At this point, the small wheels of the wheelchair rise up, the lock automatically closes and the wheelchair is ready to drive. In another known solution, the drive is connected by mounting two clamps located at the ends of the drive to the front tubes of the wheelchair frame.

The disadvantage of the described solutions is the need to mount additional elements to the wheelchair as well as the manual fixing the electric drive with the participation of another person who will help the wheelchair user in the connection process.

The auxiliary wheelchair mobility system is known from the description of the invention US 2016317368 which comprises a frame, at least one wheel-bearing part and at least one steering element or handlebar, wherein the bearing part is connected to the frame such that it rotates concentrically about its own axial axis under the action of the steering element. The system also comprises means for rotating the bearing part concentrically in relation to an axis substantially parallel to the rotation axis of the wheel. The auxiliary mobility system for a wheelchair comprises horizontal means for regulating the horizontal distance of the frame in relation to the chair in the longitudinal direction of the movement of the chair itself. Additionally, the auxiliary mobility system for a wheelchair comprises vertical means for regulating the vertical distance of the frame in relation to the rolling floor of the chair. The horizontal regulation means are embodied by a telescopic system, wherein one end thereof is connected to the frame and the other end is connected to the chair. The position of the rod is adjusted by means of an implement movable by guides located on the frame.

The presented solution has a very complicated and elaborated construction as well as the way of adjusting the rod position connecting the auxiliary system to the wheelchair. The construction includes a manual coupling system and requires the participation of another person who is not a wheelchair user who will help to manually connect the wheelchair to the auxiliary mobility system. Moreover, on the wheelchair there must be a fixed socket that is used to attach the end of the connecting rod. Also, to reverse the changes, i.e. disconnecting the wheelchair from the auxiliary system, the solution requires a person other than the wheelchair user.

The method according to this invention involves activating manually the drive control in which unit is equipped after manually setting the length of a variable length element connecting the drive unit to the wheelchair with a specified seat length. The powered element connecting the unit with the wheelchair moves in the plane of symmetry of the unit backwards and downwards until the connecting element rests on the axle connecting the large wheels of the wheelchair and the locking end located at the end of variable length connecting element engages on the axle. The unit frame connected to the element connecting the drive unit to the wheelchair also moves at the same time. The horizontal segment of the frame, moving towards the wheelchair in a plane parallel to the ground, is placed under the horizontal element of the wheelchair i.e. footrest, intended for the feet of a wheelchair user, by lifting the small front wheels of the wheelchair upwards. The horizontal segment of the frame moves until the wheelchair frame is placed behind the internal sub-assembly which the horizontal segment of the frame is equipped with and is additionally locked with a bolt attached to the connecting element.

The drive unit that is a subject of the invention is equipped with a frame mounted on a clamp mounted in parallel rotation on a vertical part of the steering system to which the wheel and the steering wheel are attached. A frame consisting of a part with a horizontal edge line extending to the part located at an acute angle to the ground is attached to the clamp. The sides of the frame consist of two parallel plates comprising a horizontal part and a rising part in relation to the ground, where the edge line of both parts preferably form an obtuse angle. Between the parallel plates there is a rotary element attached to both frame plates, on which the element connecting the drive unit with the wheelchair is rotationally mounted, wherein the connecting element has a variable length. The connecting element at the other end is equipped with a locking part adapted to be attached to the axle connecting the large wheels of a wheelchair. The connecting element preferably has a telescopic structure and is equipped with a clamp stabilizing its length. In addition, there is a bolt on the connecting element that blocks the horizontal frame segment. The drive sub-assembly at the one end is attached to the connecting element, wherein the opposite end is attached to the maintaining element of the drive sub-assembly. The element holding the end of the drive sub-assembly is located between the frame plates near the clamp mounted on the vertical part of the steering system. The horizontal segment of the frame is equipped with two sub-assemblies, external and internal, attached to the parallel plates of the frame, preferably rotatable, facilitating the entry of this end under the footrest of the wheelchair. The ends of the internal sub-assembly are placed in guides located on parallel plates. On the steering system, the unit has buttons controlling the operations of the drive unit, the first button is used to connect the drive unit and the second one is used to disconnect it from the wheelchair.

The method and the unit according to the invention allow to easily connect a wheelchair with a drive transforming a wheelchair into a power wheelchair in a few seconds. It is a perfect solution that allows people to maintain independence and freedom of traveling alone. The process of connecting an additional drive to a wheelchair does not require mounting any additional elements on the structure of the wheelchair. The wheelchair user can connect the wheelchair with the drive or disconnect the drive by oneself. This process does not require the participation of a person other than the wheelchair user.

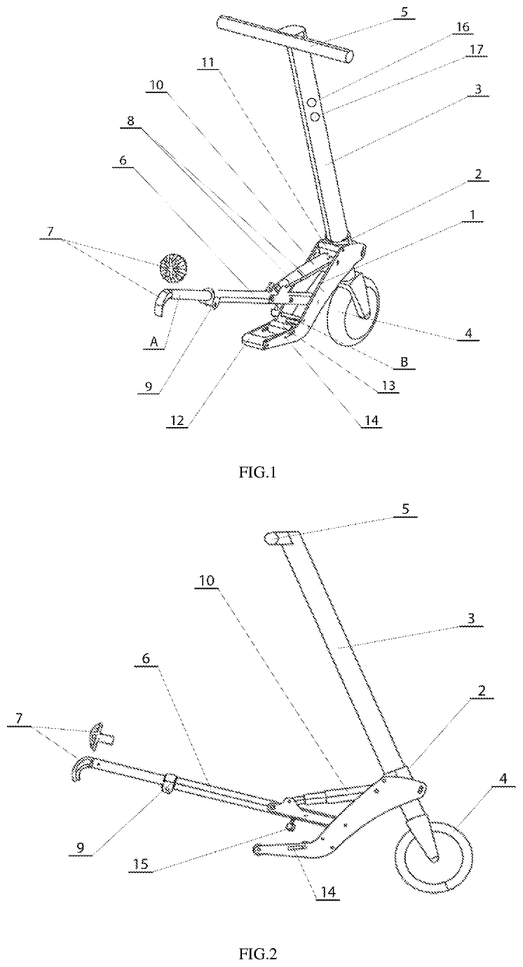

The solution which is the subject of the invention is shown in the drawing, in which FIG. 1 shows an exemplary drive unit in a general view, FIG. 2—in a side view.

### EXAMPLE

The drive unit that is a subject of the invention is equipped with a frame (1) mounted on a clamp (2) mounted in parallel rotation on a vertical part of the steering system (3) to which the wheel (4) and the steering wheel (5) are attached. A frame (1), consisting of a part with a horizontal edge line extending to the part located at an angle slightly smaller than the right angle to the ground, is attached to the clamp (2). The sides of the frame (1) consist of two parallel plates (8), comprising a horizontal part and a rising part in relation to the ground, where the edge line of both parts preferably form an angle slightly larger than the right angle. Between the parallel plates (8) of the frame (1) there is a rotary element attached to both frame (1) plates (8), on which the element connecting (6) the drive unit with the wheelchair is rotationally mounted. The connecting element (6) has a telescopic structure that allows to change its length and maintain it by locking it with a stabilizing clamp (9) located on the element (6). In addition, there is a bolt (15) on the connecting element (6). The connecting element (6) at the other end is equipped with a locking part (7) adapted to be attached to the axle connecting the large wheels of a wheelchair. The drive sub-assembly (10) at the one end is attached to the connecting element (6), wherein the opposite end is attached to the maintaining element (11) of the drive sub-assembly (10). The maintaining element (11) is located between the parallel plates (8) near the clamp (2) mounted on the steering system (3). The horizontal segment of the frame (1) is equipped with two sub-assemblies, external (12) and internal (13), which are rotatably mounted, facilitating the entry of the frame (1) end under the footrest of the wheelchair. The ends of the internal sub-assembly (13) are placed in guides (14) located on the parallel plates (8) of the frame (1) what allows the additional sliding movement of this sub-assembly. On the vertical part of the steering system (3) there are two buttons (16) and (17) to control the operation of the unit.

Before the connection the wheelchair to the drive unit, the distance between points A and B is set, which is a characteristic value for a given copy of the wheelchair which design is always adapted to the measurements of the user. Point A is established by adjusting the length of the element connecting (6) the drive unit with the wheelchair, using its telescopic structure and blocking the set length with the help of a stabilizing clamp (9). Point B is determined by moving the internal sub-assembly (13) belonging to the horizontal segment of the frame (1) in the guides (14). Then, by means of the first button (16), a drive sub-assembly (10), preferably an electric actuator, is activated. The drive sub-assembly (10) moves the connecting element (6) until the locking part (7) located at the end of the connecting element (6) is placed on the axle connecting the large wheels of the wheelchair. Simultaneously with the movement of the connecting element (6), the frame (1) moves towards the wheelchair in a such way that the horizontal segment of the frame slides under the footrest of the wheelchair by lifting it up and thus raising the front wheels of the wheelchair. The wheelchair frame tube supporting the footrest is located behind the internal sub-assembly (13). In addition, the movable bolt (15) located on the connecting element (6) places between the user's feet, additionally pressing the footrest against the horizontal segment of the frame (1). The wheelchair is equipped with an additional drive unit and becomes a three-wheeled wheelchair. This allows the user to overcome longer distance and routes with uneven ground. The desired direction of the travel is obtained by manipulating the steering wheel (5) of the steering system (3) and the power source is the battery which the unit is equipped with. Using the second button (17), the drive sub-assembly (10) is activated what lifts the connecting element (6) and thus the locking part (7) of this element is removed from the wheelchair axle and the bolt (15) is unlocked. Frame (1) goes out from under the footrest. The front wheels of the wheelchair lower and the wheelchair becomes a wheelchair with a hand drive.

1. The method of mounting the drive unit to a wheelchair by setting manually the length of a variable length element connecting the unit to a wheelchair, characterized in that the connecting element (6), that connects unit to a wheelchair, is driven by a drive sub-assembly (10) and it moves in the symmetry of the unit towards the wheelchair and towards the ground until the connecting element (6) rests on the axle connecting the large wheels of the wheelchair and simultaneously with the movement of the connecting element (6) that connects unit to a wheelchair unit frame (1) moves towards the wheelchair wherein the horizontal segment of the frame is placed under the horizontal element of the wheelchair i.e. footrest and lifts the small front wheels of the wheelchair upwards.

2. The method according to claim 1, characterized in that the driven connecting element (6) that connects unit to a wheelchair moves until it engages the locking part (7) on the axle of the wheelchair wherein the locking part (7) is located at the end of the connecting element (6).

3. The method according to claim 1, characterized in that the horizontal segment of the frame (1) moves until the wheelchair frame is positioned behind the internal sub-assembly (13) belonging to the horizontal segment of the frame (1).

4. The method according to claim 1, characterized in that the position of the horizontal segment of the frame (1) is additionally locked with the bolt (15) attached to the connecting element (6).

5. A wheelchair drive unit equipped with a steering system having a wheel and a steering wheel, to which a frame connected to a connecting element of variable length is attached, where the sides of the frame consist of two parallel plates, characterized in that the frame (1) is mounted on a clamp (2) mounted in parallel rotation on a vertical part of the steering system (3) where the frame (1), equipped with two parallel plates (8), comprises of two segments, i.e. a horizontal one with the edge line that is horizontal to the ground and a rising one that rises from the ground with the edge line forming preferably an acute angle with the ground and there is a connecting element (6) that connects unit with the wheelchair that is attached to the frame (1), while the connecting element (6) is connected to the end of the drive sub-assembly (10), while the other end of the drive sub-assembly (10) is connected to the maintaining element (11) attached to the plates (8) of the frame (1).

6. The unit according to claim 5, characterized in that the frame (1) is mounted on a clamp (2) mounted in parallel rotation on a vertical part of the steering system (3).

7. The unit according to claim 5, characterized in that the edge line of the parallel plates (8), comprising the sides of the frame (1), preferably forms an obtuse angle.

8. The unit according to claim 5, characterized in that the connecting element (6) that connects unit to a wheelchair is mounted on a rotating element attached to both plates (8) of the frame (1).

9. The unit according to claim 5, characterized in that the connecting element (6) preferably of a telescopic structure, at its free end is equipped with a locking part (7) of a structure adapted to be mounted on the axle connecting the large wheels of a wheelchair.

10. The unit according to claim 5, characterized in that the connecting element (6) that connects unit to a wheelchair is equipped with a clamp (9) stabilizing the length of the connecting element (6).

11. The unit according to claim 5, characterized in that the maintaining element (11) that holds the end of the drive sub-assembly (10) is located between the plates (8) of the frame (1) near the clamp (2) mounted on the vertical part of the steering system (3).

12. The unit according to claim 5, characterized in that the horizontal segment of the frame (1) is equipped with two sub-assemblies, external (12) and internal (13), preferably rotatably attached to parallel plates (8) of the frame (1).

13. The unit according to claim 5, characterized in that the ends of the internal sub-assembly (13) are placed in the guides (14) on the parallel plates (8) of the frame (1).

14. The unit according to claim 5, characterized in that the connecting element (6) that connects unit to a wheelchair is equipped with a bolt (15) blocking the horizontal segment of the frame (1).

15. The unit according to claim 5, characterized in that on the steering system (3) there are two control buttons where the first button (16) connects the drive unit and the second button (17) disconnects it.
